(19) United States
(12) Patent Application Publication
(10) Pub. No.: US 2005/0177512 A1
(43) Pub. Date: Aug. 11, 2005

(54) Device for protecting against unauthorised use of software

(76) Inventors: Bernd Peeters, Geesthacht (DE); Wulf Harder, Geesthacht (DE)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/512,038

(22) PCT Filed: Mar. 22, 2003
(86) PCT No.: PCT/EP03/03003

(30) Foreign Application Priority Data
Apr. 22, 2002 (DE) 202066282

(51) Int. Cl. H04K 1/00; G06F 17/60

(52) U.S. Cl. 705/51; 726/27

(57) ABSTRACT

A device for protecting against unauthorized use of software, whereby a first wireless device exchanges data directly or indirectly with a process running the software on a computing system and the process runs incorrectly or in an error condition if the exchanged data contain errors.

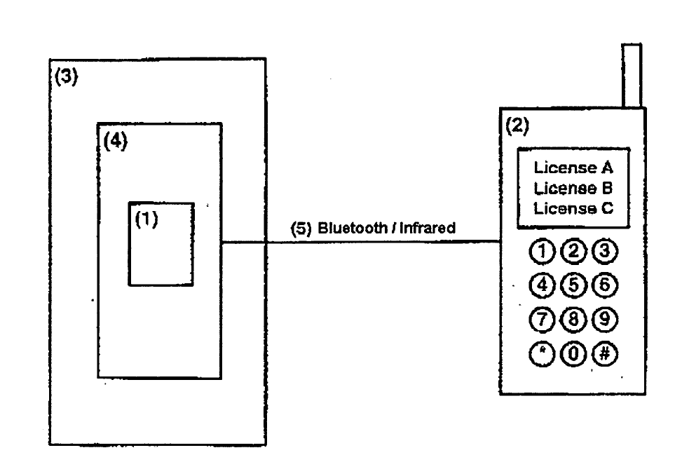

The invention relates to protection against the unauthorized use of software

State-of-the-art: A dongle must often be connected to the PC for software to be used. The protected application exchanges data with the dongle and functions correctly only if the exchanged data are without errors. The dongle is usually distributed together with the protected application. Since the dongle can be reproduced only with great difficulty or not at all without knowledge of the secret technical details, unauthorized use of the application is prevented. Many dongles contain an EEPROM, in which data regarding the software use licenses are stored. These data can also be transmitted to the dongle over the Internet, for example, if it is already in the user's possession. Data regarding usage, for example use times, can also be saved. Time-limited licenses, among other things, can be implemented in this manner.

The international disclosure WO 97/39553 describes a device for authentication, in which a wireless component (referred to as a “token”) exchanges data with, for example, a PC or similar device (referred to as a “node”), whereby it is ensured that the component be within a predefined distance of the PC. The object of this device is to prevent the use of the “node” by unauthorized persons. For example, the use of a PCs or a door is only possible if an authorized individual carrying the component on his/her person is located no farther than a predefined distance from the PC or door.

The disadvantage of a dongle as a copy protection device lies in the difficulty in use involved with insertion of the component. The user must find the proper interface on the PC and attach or remove the component there. This is time-consuming if the user works with or on various PCs in parallel or sequentially, but has only one dongle. A further disadvantage is that the component is easily forgotten when the user changes location if it is connected to the PC, since then it is usually out of sight of the user. If the component can store dynamic license data, then a further disadvantage is experienced in that the user can only read the current license data if the component is connected to a PC and a suitable program for displaying license data was started on the PC.

The device described for authentication during the use of a PCs offers no protection against the unauthorized use of software installed on the PC.

The present invention is based on the object of creating a device for protecting against unauthorized use of a protected application that can be easily connected to a computing system running said application. An embodiment of the invention should make the software license data easily accessible to the user, even if the device is not connected with the computing system.

This object is solved by Claim 1. Advantageous embodiments of the invention are specified in the dependent claims. A device 2, which exchanges data with a protected application 1 data, has a wireless connection with the computing system 3, such as a PC, which runs the application 1. The data exchange is implemented in the protected application 1 by a known copy protection procedure that works with a hardware device, whereby the any copy protection procedure can be selected with regard to the present invention. A key factor is that the user is no longer compelled to connect the device 2 to the PC 3 via a plug connection. The user can carry the device 2 on his/her person, for example. As soon as the user sits at the PC 3, the copy protection procedure implemented in the application 1 can work, provided that the application 1 exchanges data with the wireless device. This is covered in Claim 1.

The wireless data transfer could, for example, take place via ultrasound. For the protection of domestic animals, transmission by infrared or another wireless transmission technology (such as “Bluetooth”) is preferred, as covered in Claim 2.

It is furthermore desirable to have easy access to license data stored in the device, even without a connection to a PC. The solution to this is described in Claim 3. The wireless device 2 has a display on which the license data can be shown at any time. The power supply of the device 2 could be handled with batteries, rechargeable batteries and/or solar cells.

In order to achieve the characteristics described above and improve the ease of use, according to Claim 4, the copy protection functions can be integrated in a mobile telephone (such as a GSM or UMTS device), a PDA, a hand-held computer, a wristwatch or a combination of these. If a user carries this device, no further device must be carried for the copy protection function. Furthermore, integration of copy protection functionality in a mobile telephone promotes wide, cost-effective propagation of that functionality. The devices listed are only example of possible devices suitable for integration. Various hybrid forms of such devices already exist. In addition, the precise designations are subject to fashion trends and are not important for the present claims.

Claims 5 to 11 describe various transmission methods for license data.

If the device 2 is a mobile telephone, there is the option of transmitting a license value with a transaction via a direct telephone connection, which could be charged on the telephone bill. Mobile telephones usually offer Internet access, by means of which license values could also be transferred. However, an indirect telephone or Internet link is also possible via a PC connected to the device 2. In Claims 5 and 6, these cases are also covered for devices other than a mobile telephone.

Claim 7 provides for the transfer of license information between wireless devices 2 and 7, for example directly over an infrared link or indirectly via an Internet connection. These forms of transmission are also suitable for trading license values between users.

Furthermore, according to Claim 8, it is possible to transfer a license value to a PC 3. This may be desirable if a user will use an application 1 only on a particular PC 3. A return transmission to the wireless device 2 in case of a location change is also feasible. Saving of license values on the PC 3 could take place on the PC processor or on a security chip installed or mounted in a fixed manner in the PC.

Since distribution of software 1 often occurs together with a dongle 6 that stores the license data, it must be possible to transfer license values from a dongle 6 to a wireless device 2. The solution to this is described in Claim 9. According to Claims 10 and 11, the dongle 6 can be connected to a PC or also to a wireless device 2 or 7 for transmitting license data and/or in accordance with Claim 12, it can be a USB device or a SIM card.

For the case that a user would like to use a protected application 1, which has no wireless communication option, according to Claim 13 a plug connection can be installed on the inherently wireless device 2, such as a USB- or FireWire connection, as described in Claim 14. However, other forms of physical connection are also conceivable.

Claim 15 describes an option for reducing the frequency of access to the wireless device 2. The process 4 running the protected software 1 exchanges data with a security chip installed in the PC. This security chip could also be the PC processor itself, which would result in a speed advantage. The security chip exchanges data with the wireless device 2. This exchange can take place with much lower frequency that the exchange of data between the process 4 and the security chip. In the end, an indirect exchange of data occurs between the process 4 and the wireless device 2, and the protected software 1 only works without error if all exchanged data are error-free.

For the sake of better understanding, terms in the preceding discussion and in the claims have been labeled with reference numbers that are included in part in the following description of an embodiment. The embodiment refers to Drawing 1. A mobile telephone 2 connected with a PC 3 has copy protection functionality. A license value is transmitted via a telephone link to the mobile telephone 2, and the use of the copy protection function is enabled. The license value stored in the mobile telephone 2 can be called up on the display of the mobile telephone 2. The mobile telephone 2 and the process 4 running the active application 1 on the PC 3 exchange data 5 with the assistance of the copy protection function. If the data contain errors, the application 1 deviates from its intended behavior. This prevents proper utilization of the application 1 if the license value is missing, thus protecting the application 1 against unauthorized use.

1. A device for protecting against unauthorized use of software, whereby a first wireless devices exchanges data directly or indirectly with a process running the software on a computing system and the process runs incorrectly or in an error condition if the exchanged data contain errors.

2. A device according to claim 1, characterized in that the replacement of the data takes place via infrared or radio signals.

3. A device according to claim 1, characterized in that the first device has a display on which the software license data for the use of protected software can be displayed.

4. A device according to claim 1, characterized in that the first device is a mobile telephone, a PDA, a hand-held computer, a wristwatch or a combination of these.

5. A device according to claim 1, characterized in that the first device saves or changes software license data in a transaction and this transaction data is transmitted or received via a direct or indirect telephone connection.

6. A device according to claim 1, characterized in that the first device saves or changes software license data in a transaction and this transaction data is transmitted or received via a direct or indirect Internet connection.

7. A device according to claim 1, characterized in that the first device saves or changes software license data in a transaction and this transaction data is transmitted or received via a direct or indirect connection to or from a second wireless device.

8. A device according to claim 1, characterized in that the first device saves or changes software license data in a transaction and this transaction data is transmitted or received via a direct or indirect connection to or from a PC.

9. A device according to claim 1, characterized in that the first device saves or changes software license data in a transaction and this transaction data is transmitted or received via a direct or indirect connection to or from a dongle.

10. A device according to claim 9, characterized in that the dongle is connected with a PC.

11. A device according to claim 9, characterized in that the dongle is connected with the first or second device.

12. A device according to claim 9, characterized in that the dongle is a smart card, a SIM card or a USB device.

13. A device according to claim 1, characterized in that the first device can be connected to a PC or a second device via a plug connection.

14. A device according to claim 13, characterized in that the plug connection is a USB or FireWire connection.

15. A device according to claim 1, characterized in that the wireless device has an indirect connection via a security chip with the process installed or mounted in a fixed manner in the computing system.
